(19) United States
(12) Patent Application Publication
(10) Pub. No.: US 2026/0098484 A1
(43) Pub. Date: Apr. 9, 2026

(54) LUBRICATION WHEEL FOR A SPEED REDUCER OF A TURBOMACHINE

(71) Applicant: SAFRAN TRANSMISSION SYSTEMS, Colombes (FR)

(72) Inventors: Romain Thierry BOSSET, Moissy-Cramayel (FR); Loic FRANCOIS, Moissy-Cramayel (FR); Frederic Nicolas Francois LAISNEZ, Moissy-Cramayel (FR); Antoine Jacques Marie PENNACINO, Moissy-Cramayel (FR)

(21) Appl. No.: 19/346,721

(22) Filed: Oct. 1, 2025

(30) Foreign Application Priority Data
Oct. 3, 2024 (FR) 2410649

(51) Int. Cl. F01D 25/18; F16H 57/04

(52) U.S. Cl. CPC F01D 25/18; F16H 57/0479; F16H 57/0482; F05D 2260/40311; F05D 2260/98

(57) ABSTRACT

A lubrication wheel for a speed reducer of a turbomachine, including an annular oil passage cavity which extends around the axis, an annular slot for supplying the cavity, and pipes for the passage of oil by centrifuging from the cavity into the pipes, and a frustoconical rim for collecting oil at the level of the slot, the wheel being formed by the assembly of at least two parts.

### TECHNICAL FIELD OF THE INVENTION

The present invention relates in particular to a lubrication wheel for a speed reducer of a turbomachine, in particular for an aircraft, as well as a reducer and a turbomachine comprising such a wheel.

### TECHNICAL BACKGROUND

The prior art in this field comprises in particular the documents FR-A1-3 036 763, FR-A1-3 047 279, FR-A1-3 041 054, FR-A1-3 065 268, FR-A1-3 065 270, FR-A1-3 065 773, WO-A1-2015/008000, and WO-A1-2018/185186.

The role of a mechanical reducer is to modify the speed and torque ratio between the input axle and the output axle of a mechanical system.

The new-generation dual flow turbomachines, particularly those with a very high bypass ratio, comprise a mechanical reducer to drive a shaft of a fan.

The usual purpose of the reducer is to convert the rotational speed referred to as high speed of the shaft of a power turbine into a slower rotational speed for the shaft driving the fan.

Such a reducer comprises a central pinion, referred to as sun gear, a ring gear and pinions referred to as planet gears, which are engaged between the sun gear and the ring gear. The planet gears are held by a frame referred to as planet carrier. The sun, the ring gear and the planet carrier are planetaries because their axes of revolution coincide with a longitudinal axis of the turbomachine. The planet gears each have a different axis of revolution equally distributed on the same operating diameter around the axis of the planetaries. These axes are parallel to the longitudinal axis.

There are several reducer architectures. In the prior art of the dual-flow turbomachines, the reducers are of the planetary or epicyclic type. In other similar applications, there are architectures referred to as differential or “compound”.
In a planetary reducer, the planet carrier is stationary and the ring gear is the output shaft of the device which rotates in the opposite orientation of the sun gear.
In an epicyclic reducer, the ring gear is stationary and the planet carrier is the output shaft of the device which rotates in the same orientation as the sun gear.
On a compound reducer, no element is attached in rotation. The ring gear rotates in the opposite direction of the sun gear and of the planet carrier.

The reducers may consist of one or more gearing stages. This gearing is ensured in different ways such as by contact, friction or magnetic field.

There are several types of contact gearing such as straight, helical or herringbone toothings.

There are several solutions for lubricating such a reducer.

FIG. 1 illustrates a planet carrier 10 as described in the application FR-A1-3 036 763. This planet carrier 10 comprises a cylindrical body 12 connected at one longitudinal end to an annular wall 14 supporting parallel axles 16 for rotation of the planet gears 18. The axles 16 are evenly distributed around the axis A of rotation of the planet carrier and are secured to one of their longitudinal ends to the aforementioned annular wall 14. A lubrication wheel 20 is mounted and fixed to the opposite longitudinal ends of the axles 16.

In the case shown, the lubrication wheel 20 is secured to the planet carrier 10 by virtue of its connection to the axles 16 supporting the planet gears 18. The lubrication wheel 20 is therefore designed to be rotated during operation about the axis A by being secured to the rotor of the reducer.

The lubrication wheel 20 is generally annular about the axis A and comprises hydraulic connections at its external periphery to the axles 16 of rotation of the planet gears 18. The wheel 20 comprises means for lubricating, on the one hand, the bearings mounted between the axles 16 and the planet gears 18, and, on the other hand, gearing teeth of the planet gears 18 and the sun gear 22. These lubrication means comprise an annular groove 24 located at the internal periphery of the wheel 20 and opening radially inwards, i.e. towards the axis A.

Lubricant nozzles, carried by a stator of the reducer or turbomachine, are arranged radially inside the wheel (they are not shown in FIG. 1) and spray lubricant radially outward directly into the groove 24 of the wheel to feed the lubrication means.

The lubricant is fed to the nozzles by a pump in a lubrication unit of the turbomachine, which delivers a predetermined flow rate of lubricant to the nozzles. With the current technology described above, the lubricant sprayed into the groove is conveyed to the lubrication means by centrifugal effect only.

The wheel therefore distributes oil under pressure in the reducer using centrifugal forces generated during operation.

In the document FR-A-3 103 241, the wheel comprises at its internal periphery an annular cavity, which is supplied with oil by nozzles that spray oil axially into the cavity through an annular slot in the wheel. The cavity is in fluid communication with radial pipes for conveying oil by centrifugal effect to the elements of the reducer that require lubrification.

The present application focuses on the latter technology and proposes an improvement which, in particular, makes it easier to manufacture. The wheel has, in fact, an inner periphery of a relatively complex shape that is difficult to obtain from a metal casting. One solution would be to use additive manufacturing, but this is expensive and difficult to industrialize.

Furthermore, when the speed of rotation of the wheel is low, the centrifugal forces to which the oil is subjected during operation are low, and therefore the oil can flow slowly through the radial pipes of the wheel. In cases where the oil flow supplied by the nozzles exceeds the oil flow rate in the pipes due to centrifugal effect, oil is stored in the cavity, which can be treated to optimize lubrication.

The present invention provides a solution to at least some of the above problems, which is simple, effective and economical.

### SUMMARY OF THE INVENTION

The invention proposes a lubrication wheel for a speed reducer of a turbomachine, in particular of an aircraft, said wheel being configured to be rotated about an axis and having a generally annular shape about said axis, the wheel comprising:
at its internal periphery an annular oil passage cavity which extends around said axis,
at its internal periphery an annular oil supply slot which extends around said axis and which opens out in the axial direction into said cavity for the purpose of supplying it with oil, and
oil passage pipes extending radially with respect to said axis and the radially internal ends of which are connected to said cavity for the passage of oil by centrifugation from the cavity into the pipes,

characterized in that the internal periphery of the wheel comprises a frustoconical rim for collecting oil at the level of said slot, and in that this frustoconical rim extends around said axis and is formed by a first annular part mounted and fixed axially in an annular body which defines at least part of the cavity and the pipes.

The frustoconical rim is configured to guide and accommodate oil, while allowing oil retention, particularly when the oil flow rate feeding the wheel is greater than the oil flow rate circulating through its pipes. The rim can protrude axially on the upstream side of the oil supply with respect to the slot. It may also project radially with respect to the inner periphery of the slot and the cavity. The design of the rim improves oil supply but may require an unusual design of the wheel, particularly to manage the assemblies and seals. In addition, the wheel is formed by assembling at least one annular part and an annular body, the part comprising the frustoconical rim. This makes it easier to manufacture the wheel and to envisage other ways of manufacturing the wheel other than by additive manufacturing.

The spinning wheel according to the invention may comprise one or more of the following characteristics, taken in isolation from each other, or in combination with each other:
said frustoconical element is a surface or formed by a surface;
said frustoconical element is formed by inclined edges of fins; these fins having the function of ensuring oil entrainment around the axis;
said cavity comprises at its internal periphery a frustoconical element which extends around said axis and one longitudinal end of smaller diameter of which is connected to a longitudinal end of smaller diameter of said frustoconical rim;
said frustoconical element is formed by said body or by said first part;
said cavity is delimited axially by two annular side walls, a first of these walls having its internal periphery delimiting said slot internally; this first wall can be likened to a front closure wall of the cavity, insofar as it is located on the oil supply side;
said first wall is located axially between the frustoconical element and the frustoconical rim;
said first wall is formed by said body or by said first part or by a second annular part mounted and fixed axially to said body;
when the first wall is formed by said first part, the first wall and the first part are connected together by an annular row of connecting fingers which pass radially through the cavity and/or the slot;
a second of the side walls has its inner periphery connected to a longitudinal end of greater diameter of said frustoconical element; this second wall can be assimilated to a dorsal inner wall of the cavity, insofar as it is situated on the side opposite the oil supply;
said first part comprises a cylindrical centering rim which comprises an external cylindrical surface capable of cooperating by centering with an internal cylindrical surface of said body;
said cylindrical surfaces are located at the internal periphery of the wheel;
at least one O-ring seal is mounted in an annular groove in one of the cylindrical surfaces to sealing cooperation with the other of the cylindrical surfaces;
said first part is fixed to the body by welding or screwing;
the slot has an internal diameter which is greater than the external diameter of the frustoconical rim;
the internal diameter of the slot is smaller than the external diameter of the frustoconical element;
at least some of the pipes communicate with axial oil passage channels and are plugged at their radially external ends by said body or by attached plugs;
the rim flares axially on the side opposite the cavity;
the rim has a free end of larger diameter which is located axially on the side opposite the cavity.

The present invention also relates to a speed reducer for a turbomachine, this reducer comprising a sun gear movable in rotation about an axis, a ring gear that extends around the axis and the sun gear, and planet gears that are situated between the sun gear and the ring gear and that are in mesh with the sun gear and the ring gear, the planet gears being carried by a planet carrier which is centered on the axis and which is movable in rotation about that axis, wherein a wheel as described above is fixed coaxially to the planet carrier in order to lubricate the planet gears and/or the gearings.

The present invention also relates to a turbomachine, in particular for an aircraft, comprising a reducer as described above and at least one oil nozzle which is configured to project a jet of oil into said cavity, passing axially through said slot and passing radially outside of the frustoconical rim.

### BRIEF DESCRIPTION OF THE FIGURES

Further characteristics and advantages will be apparent from the following description of a non-limiting embodiment of the invention with reference to the appended drawings in which:

FIG. 1 is a schematic perspective view of a planet carrier of the prior art,

FIG. 2 schematically represents an axial cross-section of a turbomachine using the invention;

FIG. 3 shows a detailed cross-sectional view of a epicyclic gear reducer;

FIG. 4 is an exploded perspective view of the reducer in FIG. 3;

FIG. 5 shows a schematic cross-section of a wheel of the reducer of FIG. 3;

FIG. 6 is a schematic axial sectional view of a lubrication wheel according to a first embodiment of the invention;

FIG. 7 is a schematic axial sectional view of a lubrication wheel according to a second embodiment of the invention;

FIG. 8 is a schematic axial sectional view of a lubrication wheel according to a third embodiment of the invention;

FIG. 9 is a schematic axial sectional view of a lubrication wheel according to a fourth embodiment of the invention.

### DETAILED DESCRIPTION OF THE INVENTION

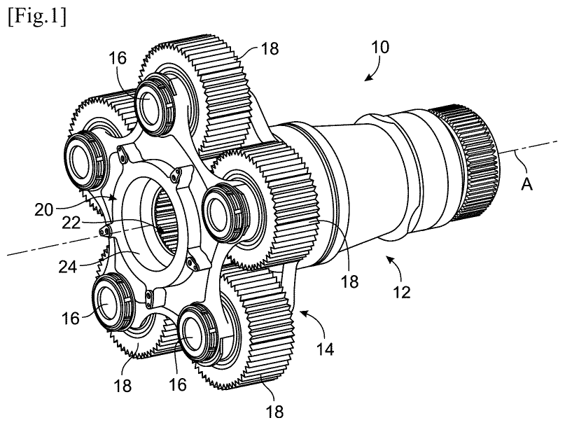

FIG. 1 has been described in the foregoing and represents the prior art to the present invention.

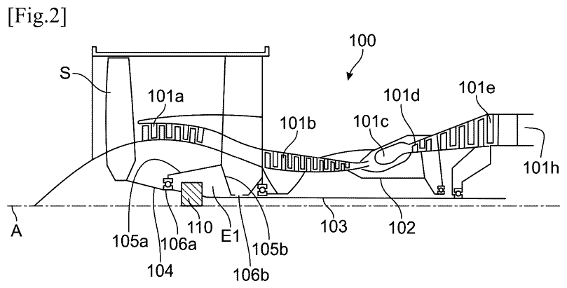

FIGS. 2 to 5 illustrate the prior art as described in the document FR-A1-3 041 054.

FIG. 1 shows a turbomachine 100 that conventionally comprises a fan propeller S, a low-pressure compressor 101a, a high-pressure compressor 101b, a high-pressure turbine 101d, a low-pressure turbine 101e and an exhaust nozzle 101h. The high-pressure compressor 101b and the high-pressure turbine 101d are connected by a high-pressure shaft 102 and together form a high-pressure (HP) body. The low-pressure compressor 101a and the low-pressure turbine 101e are connected by a low-pressure shaft 103 and together form a low-pressure (BP) body.

The fan propeller S is driven by a fan shaft 104 which is coupled to the BP shaft 103 by means of a epicyclic gear reducer 110 shown here schematically.

The reducer 110 is positioned in the upstream portion of the turbomachine. In this application, the terms “upstream” and “downstream” refer to the flow of the gases through the turbomachine.

A fixed structure comprising schematically, here, an upstream part 105a and a downstream part 105b is arranged so as to form an enclosure E1 surrounding the reducer 110. This enclosure E1 is here closed upstream by seals at the level of a bearing 106a allowing the passage of the fan shaft 104, and downstream by seals at the level of the passage 106b of the BP shaft 103.

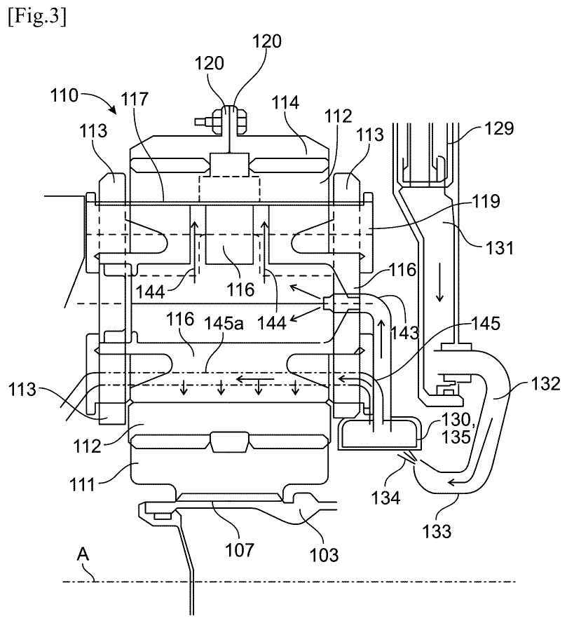

With reference to FIGS. 2 and 3, the reducer is enclosed in a ring gear 114 which is fixed by means of a support casing 120 to said stationary structure 105a, 105b with flexible means arranged to allow it to follow the possible movements of the fan shaft 104, in certain degraded operating cases for example. These attachment means are known to the person skilled in the art and are not detailed here. A brief description can be found for example in the document FR-A1-2 987 416.

The reducer 110 in this example engages on the one hand with the BP shaft 103 via splines 107 which drive a planetary gear pinion, known as the sun gear 111, and on the other hand with the fan shaft 104 which is fixed to a planet carrier 113. Typically, the sun gear 111, the axis of rotation A of which coincides with that of the turbomachine, drives a series of pinions of planet gears 112, which are evenly distributed around the circumference of the reducer 110. The number of planet gears 112 is generally defined between three and six. The pinions of planet gears 112 also rotate about the axis A of the turbomachine, gearing with internal teeth of the ring gear 114, which is mounted stationary with respect to the turbomachine, by means of the support casing 120. Each of the planet gears 112 rotates freely about a planet gear axle 116 connected to the planet carrier 113, using a bearing that may be plain, as shown in FIG. 3, or a rolling-element bearing (ball or roller bearings).

The rotation of the planet gears 112 about their planet gear axle 116, due to the cooperation of their pinions with the teeth of the ring gear 114, causes the rotation of the planet carrier 113 about the axis A, and consequently that of the fan shaft 104 linked to it, at a speed of rotation which is lower than that of the BP shaft 103.

The drive of the fan shaft 104 through the planet carrier 113 is provided by a series of centering fingers 117, evenly distributed around the circumference of the reducer 110, which extend axially from the downstream end of the fan shaft 104 and extend into bores provided in the planet carrier 113. The planet carrier 113 extends symmetrically on either side of the axles 116 of planet gear and forms an enclosure in which a function of lubricating the gears can be implemented. Closing sockets 119, at the ends of the planet gear axles 116, allow to close this enclosure at the level of the bearings of the planet gears 112.

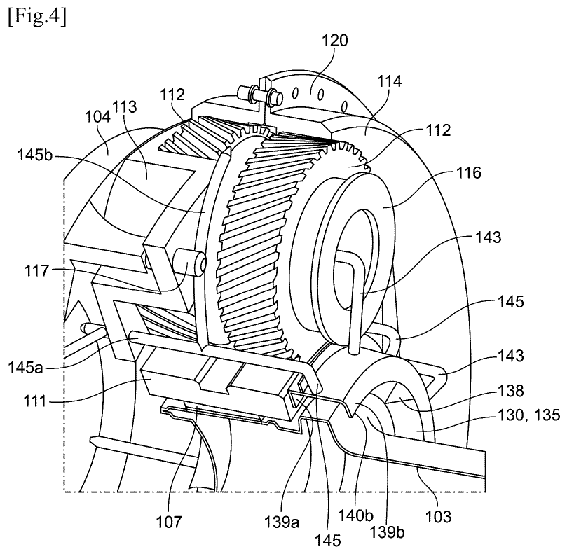

FIG. 3 shows, along with FIG. 4, the conveying of the oil towards the reducer 110 and its path inside it. Arrows show in FIG. 3 the path followed by the oil from, in this example, a buffer reservoir 131 linked to the stationary structure of the turbomachine, to the pinions and to the bearings to be lubricated. The lubrication device comprises schematically three portions which will be described below in succession, a first portion linked to the stationary structure and delivering the oil towards the rotating portions of the reducer 110, a wheel rotating with the planet carrier 113 receiving this oil, and oil distribution circuits supplied with oil by the wheel to convey it towards the places to be lubricated.

The first portion comprises at least one injector 132 whose calibrated end is constricted to form a nozzle 133. The oil is fed towards the injector through a conveying pipe 129 from the reservoir of the engine (not shown). A buffer reservoir 131 may be interposed next to the reducer 110 on the pipe, preferably at top portion so that the oil can flow towards the center of the reducer by gravity. The nozzle 133 ejects the oil in the form of a jet 134, which is formed under the pressure produced jointly by the supply pump (not shown) and by the weight of the oil column located above it. The nozzle 133 is positioned here radially inside the planet carrier 113 with respect to the axis A, and the jet 134 is oriented with a radial component directed outward from the reducer 110.

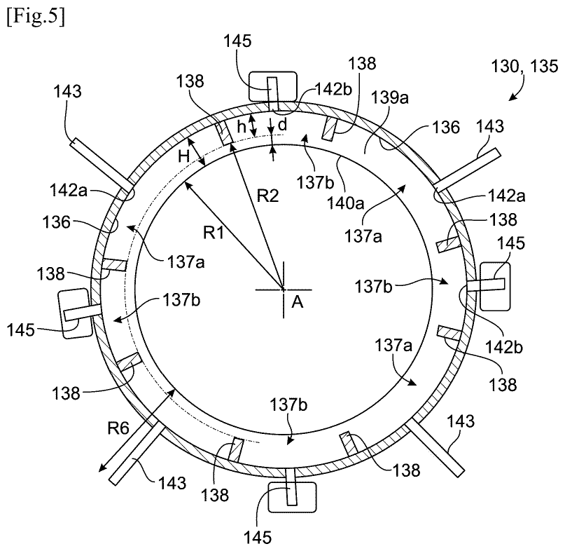

With reference to FIGS. 4 and 5, the oil receiving wheel 130 connected to the planet carrier 113 essentially comprises a cylindrical cup 135, here with a radial U-shaped cross-section, whose the U-shaped opening is oriented in the direction of the axis of rotation A. The wheel 130 is arranged on the planet carrier 113 so that the bottom 136 of the U of the cup 135 collects the oil jet 134 ejected by the nozzle 133.

The cup 135 of the wheel 130 is divided into a circumferential succession of troughs 137a, 137b separated by radially oriented walls 138 extending axially between the two side walls 139a, 139b of the U formed by the cup 135. In the example shown, the circumferential dividing walls 138 delimit two alternating series of four troughs 137a, 137b, with a same circumferential extension in one series but different from one series to the next.

Centrifugally, as the wheel 130 rotates with the planet carrier 113, the oil received on the bottom 136 of the cup 135 is driven in rotation and pressurized between the bottom 136 and the side walls 139a, 139b of the cup 135. Each cup 135a, 135b, passing successively in front of the nozzle 133 during rotation, collects a quantity of oil proportional to its circumferential extension. In effect, the radially inner edges of the walls 139a-139b-138 of a trough 137a, 137b define an entrance surface to the trough along the radial direction. This oil remains confined between the walls 138, 139a, 139b of the trough 137a, 137b as long as the oil level relative to the bottom 136 remains below the minimum height h of the walls 138 thereof relative to the bottom 136.

The internal radial edges 140a, 140b of the side walls 139a, 139b are substantially circular. Their radius R1 defines a general depth H of the cup 135 relative to the bottom 136. Preferably, the circumferential dividing walls 138 have an internal radial edge 141 located at a distance R2 from the axis A slightly greater than the radius R1 of the internal edges 140a, 140b of the side walls 139a, 139b. The height h of the circumferential dividing walls 138 in relation to the bottom 136 of the troughs 137a, 137b is therefore slightly less than the height H of the side walls 139a, 139b in relation to this same bottom 136.

In addition, the bottom 136 of each trough 137a, 137b comprises an opening 142a, 142b that communicates with a pipeline 143, 145 of an oil distribution circuit installed on the planet carrier 113.

With reference to FIGS. 4 and 5, the oil distribution circuits are of two types here. A first series of oil distribution circuits corresponds to first pipes 143, which are evenly distributed around the circumference of the reducer 110 and in equal number to that of the planet gears 112. These pipes 143 extend radially from the opening 142a in the bottom of the first series of troughs 137a and penetrate into the internal enclosure of each planet gear shaft 116, which is closed off by the planet carrier 113. The oil flowing through the first pipes 143 penetrates the internal cavity of each planet gear axle 116 and then passes, due to centrifugal force, into guide channels 144, which pass through these planet gear axles 116 in a radially oriented manner. These channels 144 open out at the periphery of the planet gear axles 116, at the level of the bearings supporting the pinions of the planet gears 112 and thus ensure the lubrication of these bearings (FIG. 3).

The second series of oil distribution circuits comprises second pipes 145 that convey, from the openings 142b in the bottom of the troughs 137b of the second series of troughs between the planet gears 112 and divide into several channels 145a, 145b. The channels 145a, 145b convey the oil to the gears formed by the pinions of the planet gears 112 and the sun gear 111, on the one hand, and the pinions of the planet gears 112 and the external ring gear 114, on the other. Each channel 145a extends axially along the pinions of a planet gear 112, between them and the sun gear 111, and forms a lubrication ramp across the entire width of the pinions. The channel 145b, which supplies the gear between the ring gear 114 and the pinions of the planet gears 112, sprays its oil into the center of the cylinder formed by each planet gear 112. As shown, each planet gear 112 is made as two parallel pinions. Their toothing are oriented diagonally with respect to the axis of rotation of the planet gear 112, so that they give a function as grooves in which the oil is driven from the middle of the cylinder to its periphery to lubricate the gear over its entire width.

The first oil distribution circuits 143-144, which lubricate the bearings supporting the planet gears, need to carry a greater flow rate of oil than the second circuits 145-145a-145b. For this reason, the circumferential extension of the troughs 137a of the first series, which correspond to them, is greater than that of the troughs 137b of the second series. Here, a ratio of two-thirds to one-third is sought in the oil flow rate during nominal operation; the circumferential extension of the two series of troughs 137a, 137b substantially duplicates this ratio.

The assembly has been presented here with reference to a reducer architecture 110 with four planet gears 112 with two series of oil distribution circuits 143-144, 145-145a-145b of different types. For other reducer architectures, the number of troughs per series may be different. Also the number of series of troughs with similar circumferential extensions can be different, depending on the types of oil distribution circuits. For example, the second oil distribution circuits could be subdivided into two, one dedicated to the gear of the pinions of the planet gears 112 with the sun gear 111 and the other dedicated to the gear with the ring gear 114. In this case, a variant of the oil recovery wheel can be realized with three series of troughs of different circumferential extensions.

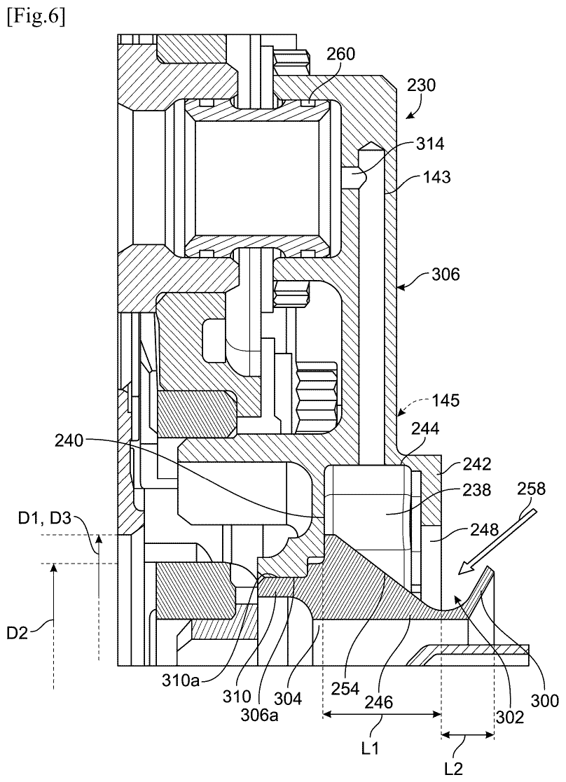

FIGS. 6 to 9 illustrate several embodiments of a wheel 230 according to the invention.

The wheel 230 comprises characteristics described in the foregoing and which are designated by the same references in FIGS. 3 to 5. It comprises in particular pipes 143 and pipes 145

The wheel 230 has a generally annular shape about the aforementioned axis A, which is not visible in FIGS. 6 to 9.

The wheel 230 comprises means for supporting the rotation shafts 116 of the planet gears of the reducer, these support means being formed by cylindrical end caps 260 engaged in internal cavities of these axles 116. The wheel 230 also comprises means for lubricating the toothing of the planet gears and the bearings of the axles 116, which comprise in particular the aforementioned pipes 143, 145.

The lubrication means also comprise an annular cavity 238 located at the internal periphery of the wheel 230 and connected to the pipes 143, 145. The pipes 143 extend substantially radially between the cavity 238 and the axles 116 for their oil supply. The pipes 145 may extend substantially radially between the cavity 238 and nozzle mounting holes or channels 145a, 145b such as those described above in relation to FIGS. 3 to 5.

The annular cavity 238 is delimited axially by two annular side walls 240, 242, referred to respectively as the first wall 240 and the second wall 242.

The annular cavity 238 is also radially delimitated by an internal peripheral wall 246 and an external peripheral wall 244.

The wall 240 extends radially between the walls 244, 246. The radially internal ends of the pipes 143, 145 open onto the wall 244.

Unlike previous technology, where the feed to the wheel 130 is radial for centrifugal accumulation, the cavity 238 of the wheel 230 is closed radially on the inside by the wall 246. The wall 246 is connected to the wall 240 and extends radially inwards from the wall 242, radially spaced therefrom. The internal periphery of the wall 242 and the wall 246 thus define between them an annular lubricating oil supply slot 248 of the cavity 238.

The wall 240 can be regarded as a front wall insofar as it is located on the oil supply side of the cavity 238. The wall 242 can be regarded as a back wall in that it is located on the opposite side to the oil supply to the cavity 238.

The cavity 238 may comprise an internal frustoconical element 254 which faces the slot 248.

The frustoconical element 254 may be a surface or may be formed by a surface. The frustoconical element 254 is then a frustoconical surface.

Alternatively, the frustoconical element 254 may be formed by inclined edges of fins 254a.

Each of the fins 254a has a generally triangular shape and comprises a first side connected to the wall 242, a second side connected to the wall 246, and a third side which is free and inclined extending from the wall 242 to the wall 246.

In the event that the cavity 238 does not include a frustoconical element 254, it is understood that the internal periphery of the wall 242 is directly connected to the wall 246.

The element 254 may have an axial dimension L1 representing at least 25% or even 50% of the axial dimension of the wall 246 and may even represent more than 100% of the axial dimension of the wall 246 insofar as the element 254 may extend to the outside of the cavity 238 through the slot 248.

The double line in FIGS. 6 to 9 illustrates a jet of oil 258 projected by a nozzle fixed to a stator of the turbomachine.

The nozzle may be slightly inclined with respect to the axis A to project the jet of oil 258 into the cavity 238, through the slot 248 and passing around a frustoconical rim 300 of the internal periphery of the wheel 230. This oil jet 258 impacts the element 254 and/or the wall 246. When the element 254 is formed by fins 254a, the oil jet 258 impacts the wall 246 and the oil is then driven into rotation by the fins 254a for centrifuging.

The rim 300 collects the oil at the level of the slot 248, forming an annular trough 302 with a U- or V-shaped cross-section.

The rim 300 extends around the axis A and may be formed by a first annular part 304 which is fitted and axially fixed in an annular body 306 which defines at least part of the cavity 238 and the pipes 143, 145.

In the drawings, it can be seen that the frustoconical element 254 has its smaller-diameter longitudinal end connected to the smaller-diameter longitudinal end of the frustoconical rim 300. The longitudinal end of greater diameter of the rim 300 is free and located on the opposite side to the cavity 238.

The wall 242 is preferably located axially between the frustoconical element 254 and the frustoconical rim 300. The connection between the aforementioned ends of the frustoconical element 254 and the rim 300 is thus preferably surrounded by the wall 242 and delimits the aforementioned slot 248 with the internal periphery of this wall 242.

The slot 248 preferably has an internal diameter D1 which is greater than the external diameter D2 of the frustoconical rim 300.

The frustoconical rim 300 may have an axial dimension L2 representing between 10 and 50%, and for example between 20 and 30%, of the axial dimension L1 of the element 254.

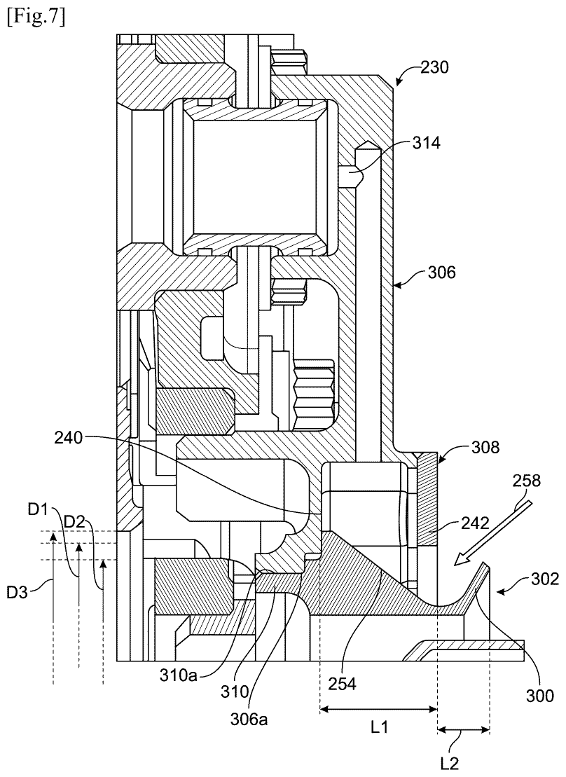

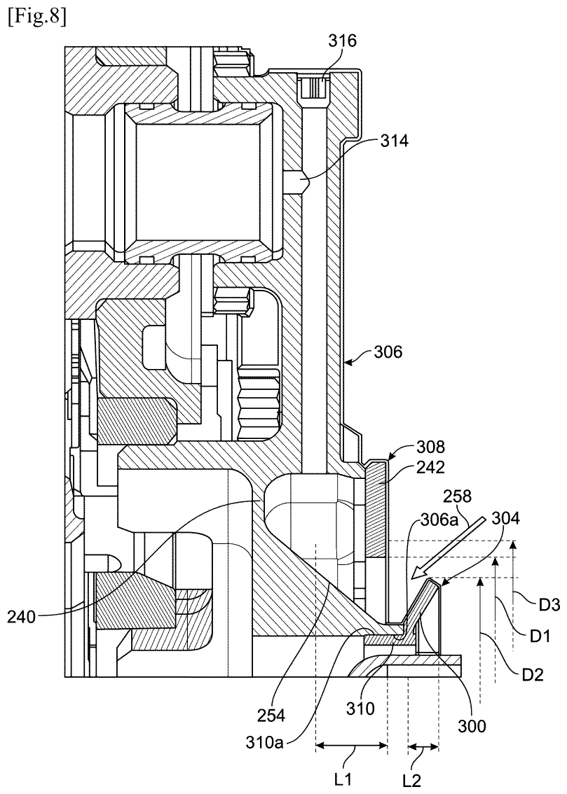

The internal diameter D1 of the slot 248 is preferably smaller than the external diameter D3 of the frustoconical element 254, as can be seen in FIGS. 7 and 8. Alternatively, the internal diameter D1 of the slot 248 may be greater than or equal to the external diameter D3 of the frustoconical element 254, as shown in FIG. 6.

In the embodiment shown in FIGS. 6 and 7, the frustoconical element 254 is formed by the first part 304. In the embodiment shown in FIG. 8, the frustoconical element 254 is formed by the body 306.

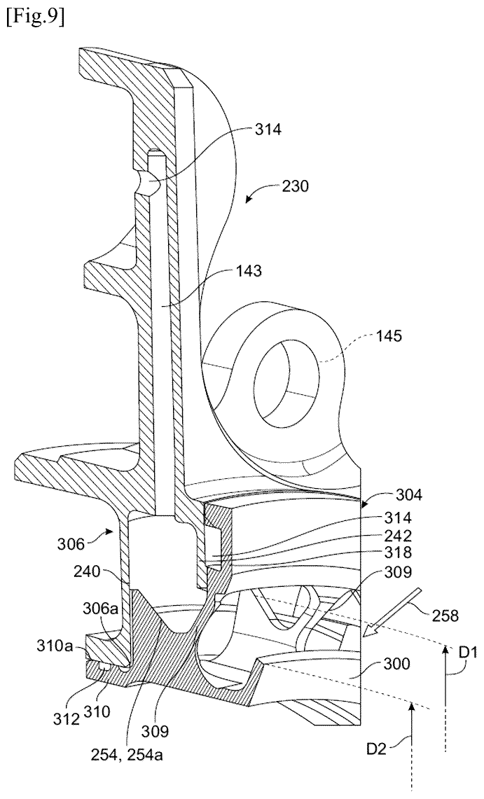

The wall 242 may be formed by the body 306, as in FIG. 6, or by the first part 304, as in FIG. 9, or by a second annular part 308 mounted and fixed axially to the body 306, as in FIGS. 6 and 8. In the latter, the wheel 230 is formed by the assembly of three annular elements, the body 306 and the two parts 304, 308.

The part 304 or parts 304, 308 can be fixed to the body 306 by welding or screwing.

In the figures, it can be seen that the pipes 143 communicate with axial oil passage channels 314. In FIGS. 6, 7 and 9, the pipes 143 are plugged at their radially external ends by the body 306 itself. In FIG. 8, the pipes 143 are plugged at their radially external ends by plugs 316 inserted in the radial direction. This last variant allows the pipes 143 to be made by drilling the body 306 radially from the outside.

In FIG. 9, where the first wall 242 is formed by the body 304, the first wall 242 is also covered axially by a sealing shell 318 associated with the body 304. Connecting fingers 309 connect this shell 318 to the frustoconical element 254, and in particular to the free edges of the aforementioned fins 254a.

The number of fingers 309 is equal to the number of fins 254a and each finger 309 is connected to a fin 254a. The fins 254a and fingers 309 may extend in radial planes passing through the axis X.

The fingers 309 form an annular array around the axis X and pass radially through the cavity 238 and/or the slot 248.

To facilitate the assembly, said first part 304 advantageously comprises a cylindrical centering rim 310 which comprises an external cylindrical surface 310a capable of cooperating by centering with an internal cylindrical surface of said body 306a.

The cylindrical surfaces 310a, 306a are located at the internal periphery of the wheel 230 in the example shown.

At least one O-ring seal 312 may be mounted in an annular groove in one of the cylindrical surfaces, such as the surface 310a, to cooperate in sealing with the other of the cylindrical surfaces, such as the surface 306a.

At least one O-ring seal 314 can be mounted between the shell 318 and the wall 242 as shown in FIG. 9.

The benefits of the lubrication wheel according to the invention include:
a reduced radial overall dimension of the technology,
an increase in oil pressure in the wheel,
a more efficient oil collection,
a simplified manufacturing, with the same performance and overall dimension, etc.

1. A lubrication wheel for a speed reducer of a turbomachine, in particular of an aircraft, said wheel being configured to be rotated about an axis and having a generally annular shape about said axis the wheel comprising:
at its internal periphery an annular oil passage cavity which extends around said axis,
at its internal periphery an annular oil supply slot which extends around said axis and which opens out in the axial direction into said cavity for the purpose of supplying it with oil, and
oil passage pipes extending radially with respect to said axis and the radially internal ends of which are connected to said cavity for the passage of oil by centrifugation from the cavity into the pipes,
wherein the internal periphery of the wheel comprises a frustoconical rim for collecting oil at the level of said slot, and in that this frustoconical rim extends around said axis and is formed by a first annular part mounted and fixed axially in an annular body which defines at least part of the cavity and the pipes.

2. The wheel according to claim 1, wherein said cavity comprises at its internal periphery a frustoconical element which extends around said axis and one longitudinal end of smaller diameter of which is connected to a longitudinal end of smaller diameter of said frustoconical rim.

3. The wheel according to claim 2, wherein the frustoconical element is formed by said body or by said first part.

4. The wheel according to claim 1, wherein said cavity is delimited axially by two annular side walls, a first of these walls having its internal periphery delimiting said slot internally.

5. The wheel according to claim 4, wherein said cavity comprises at its internal periphery a frustoconical element which extends around said axis and one longitudinal end of smaller diameter of which is connected to a longitudinal end of smaller diameter of said frustoconical rim or wherein the frustoconical element is formed by said body or by said first part, wherein said first wall is located axially between the frustoconical element and the frustoconical rim.

6. The wheel according to claim 4, wherein said first wall is formed by said body or by said first part or by a second annular part mounted and fixed axially to said body.

7. The wheel according to claim 6, wherein, when the first wall is formed by said first part, the first wall and the first part are connected together by an annular row of connecting fingers which pass radially through the cavity and/or the slot.

8. The wheel according to claim 4, wherein said cavity comprises at its internal periphery a frustoconical element which extends around said axis and one longitudinal end of smaller diameter of which is connected to a longitudinal end of smaller diameter of said frustoconical rim or wherein the frustoconical element is formed by said body or by said first part, and wherein a second of the side walls has its internal periphery connected to a longitudinal end of greater diameter of said frustoconical element.

9. The wheel according to claim 1, wherein said first part comprises a cylindrical centering rim which comprises an external cylindrical surface capable of cooperating by centering with an internal cylindrical surface of said body.

10. The wheel according to claim 9, wherein said cylindrical surfaces are located at the internal periphery of the wheel.

11. The wheel according to claim 9, wherein at least one O-ring seal is mounted in an annular groove in one of the cylindrical surfaces for sealing cooperation with the other of the cylindrical surfaces

12. The wheel according to claim 1, wherein said first part is fixed to the body by welding or screwing.

13. The wheel according to claim 1, wherein the slot has an internal diameter which is greater than the external diameter of the frustoconical rim.

14. The wheel according to claim 13, wherein said cavity comprises at its internal periphery a frustoconical element which extends around said axis and one longitudinal end of smaller diameter of which is connected to a longitudinal end of smaller diameter of said frustoconical rim or wherein the frustoconical element is formed by said body or by said first part, and wherein the internal diameter of the slot is smaller than an external diameter of said frustoconical element.

15. A speed reducer for a turbomachine, this reducer comprising a sun gear that is movable in rotation about an axis, a ring gear that extends around the axis and the sun gear, and planet gears that are situated between the sun gear and the ring gear and that are in mesh with the sun gear and the ring gear, the planet gears being carried by a planet carrier that is centered on the axis and which is movable in rotation about the axis, wherein a wheel according to claim 1 is fixed coaxially to the planet carrier in order to lubricate the planet gears and/or the gearings.

16. The turbomachine in particular for an aircraft, comprising a reducer according to claim 15 and at least one oil nozzle which is configured to project a jet of oil into said cavity, passing axially through said slot and passing radially outside of the frustoconical rim.
